(19) United States
(12) Patent Application Publication
(10) Pub. No.: US 2007/0026374 A1
(43) Pub. Date: Feb. 1, 2007

(54) System and method for the delivery of education solutions via handheld devices

(76) Inventors: Robert A. Sanregret, Haymarket, VA (US); Martha A. Sanregret, Haymarket, VA (US); Joshua A. Sigal, Encino, CA (US)

Correspondence Address: WHITE-WELKER & WELKER, LLC, P.O. BOX 199, CLEAR SPRING, MD, 21722-0199, US

(21) Appl. No.: 11/189,381

(22) Filed: Jul. 26, 2005

(51) Int. Cl. G09B 3/00

(52) U.S. Cl. 434/350

(57) ABSTRACT

The present invention is a portable solution that is ideal for a mobile workforce or industry areas with lack of infrastructure. Using the present invention on a conventional PC desktop empowers a user with the ability to create custom educational and training courses that are then converted to Palm OS or Windows CE handheld software programs. No programming is necessary, this present invention enables the user to create training in an afternoon and deliver it the next day to their work force via distribution through portable electronic devices. Therefore, users can deliver information and training to their target audience no matter where they may be located. The present invention enables users to develop education solutions on their PC using text, graphics and questions with our without the use of instruction design templates and samples. The modular software design enables user's to target specific needs through the creation of one module or a series of modules to accomplish a specific teaching or learning goal. Additionally, built in quizzes allow the user to test their knowledge using check boxes or true/false questions.

### SEQUENCE LISTING OR PROGRAM

Not Applicable

### FEDERALLY SPONSORED RESEARCH

Not Applicable

### CROSS REFERENCE TO RELATED APPLICATIONS

Not Applicable

### TECHNICAL FIELD OF THE INVENTION

This invention relates to a system and method for enabling mobile and distance learning. More specifically, the present invention relates to the delivery of education solutions via handheld devices with minimal cost, training or infrastructure requirements.

### DEFINITION OF TERMS

Mobile Learning Activity: a number of different elements that form the basis of a module.

### BACKGROUND OF THE INVENTION

Mobile learning continues to grow as it is embraced by more organizations. Employees have less time to accomplish more work and even less time for training or continuing education. Using mobile learning people enjoy the ability to easily download, review, and test on specific targeted subjects.

The present invention is a mobile content development system available that allows users to author content using a simple to use authoring environment and then, with a simple click of a button, publish to any mobile device such as a Palm OS, Pocket PC and similar mobile desktop environments. A key unique differentiator between the present invention and the prior art is the ability to create five different types of content: checklists, job aides, quizzes, tests, and mobile learning.

Other products known in the prior art such as those from Macromedia Breeze, Authorware, or Adobe can create simple graphical pages that can be published for distribution on some Pocket PCs and Palm OS devices. One major short coming which these known products is that they all require a plug-in for the flash/pdf reader and will not run on over half of the current Palm OS devices known in the prior art and in use today. Therefore it is an objective of the present invention to enable the publishing of self running mobile content that runs on all Palm OS and Pocket PC devices currently known in the prior art and future improved devices.

It is therefore another objective of the present invention to enable the publishing of self running mobile content that allows the creation and use of: quizzes, with results; checklists, with live or real time checks; tests, with results; icon creation; content editing, quicker creation and publishing ability, and smaller memory requirements.

### SUMMARY OF THE INVENTION

The purpose of the present invention is to provide a set of tools for use in creating Palm OS and Windows CE delivered education and training solutions. Rapidly design educational modules specifically targeted for short learning interventions. Deliver a more effective learning experience with materials that are synthesized and designed specifically for mobile devices.

The present invention enables a user to create an array of learning activity types such as mobile tutorials, quizzes, exams and mobile checklists. A user can also use their imagination to develop a series of new activity types. The development environment of the present invention is a simple interface that is familiar to anyone who has used any windows based applications. With the click of one button a user's learning activity can be compiled and ready to deploy on a number of handheld devices running Palm OS or Windows Mobile or the desktop of any windows based PC.

The present invention allows users to rapidly design and deploy targeted education solutions delivered over handheld devices with minimal cost, training or infrastructure requirements. Stand-alone deliverables eliminate security risks and connectivity issues without extensive IT integration and the ensuing deployment costs. The present invention is a portable solution that is ideal for a mobile workforce or industry areas with lack of infrastructure.

Using the present invention on a conventional PC desktop empowers a user with the ability to create custom educational and training courses that are then converted to Palm OS or Windows CE handheld software programs. No programming is necessary, this present invention enables the user to create training in an afternoon and deliver it the next day to their work force via distribution through portable electronic devices. Therefore, users can deliver information and training to their target audience no matter where they may be located.

The present invention enables users to develop education solutions on their PC using text, graphics and questions with our without the use of instruction design templates and samples. The modular software design enables user's to target specific needs through the creation of one module or a series of modules to accomplish a specific teaching or learning goal. Additionally, built in quizzes allow the user to test their knowledge using check boxes or true/false questions.

The present invention can be used to create a wide variety of education solutions for various industry and business needs such as: Regulatory and Compliance Information, Security Checklists, Diversity and Sexual Harassment Training, New Product Launch Tutorials, Sales and Marketing Training and Checklists, Dealer and Channel Training, Technical Specifications and Troubleshooting Tools, New Hire Training, and Safety Training and Checklists. It would be obvious to one of ordinary skill in the art to adapt the present invention to other education solutions and industrial needs beyond those taught in the present application.

The following detailed description discloses everything necessary to enable one of ordinary skill in the art to readily create and deliver a compiler development embodiment, an editing module, distribution kit to automatically load created modules to any portable electronic device, as well as sample applications, extensions and codes.

### BRIEF DESCRIPTION OF THE DRAWINGS

FIG. 1 illustrates the graphical user interface of the present invention;

FIG. 2 illustrates the Module Outline Pane of the present invention;

FIG. 3 illustrates the Preview Pane of the present invention;

FIG. 4 illustrates the Element Data Pane of the present invention;

FIG. 5 shows the file menu of the present invention;

FIG. 6 shows the edit menu of the present invention;

FIG. 7 shows the module menu of the present invention;

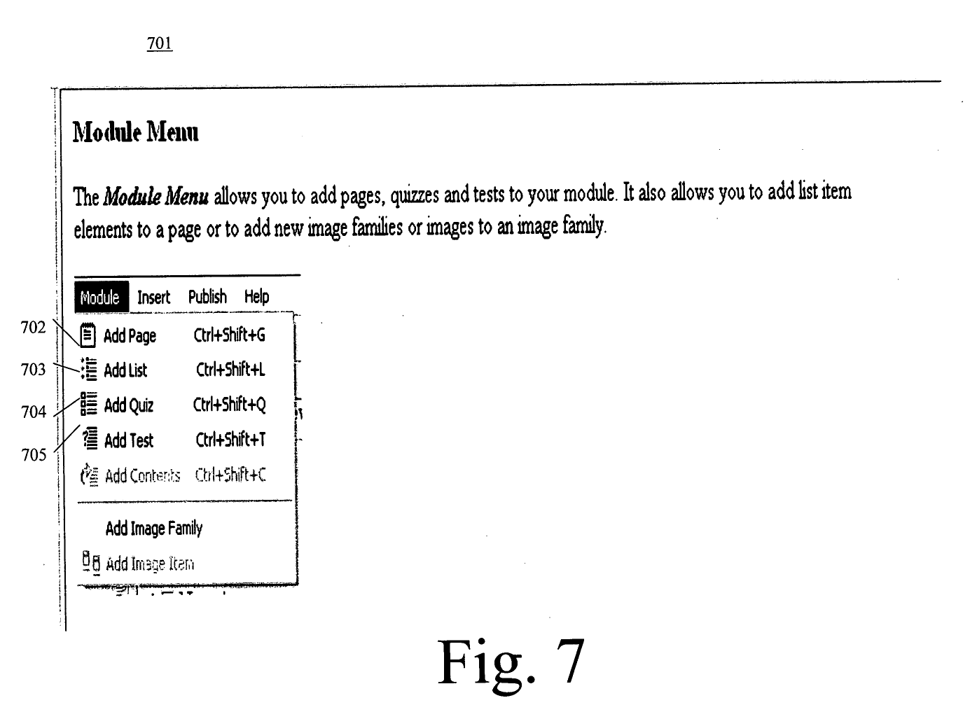

FIG. 8 shows the insert menu of the present invention;

FIG. 9 shows the view menu of the present invention;

FIG. 10 shows the publish menu of the present invention;

FIG. 11 is a screen shot of a representative user screen for module creation;

FIG. 12 is a flow chart of the Module Content Data Model;

FIG. 13 is an example of a typical module layout and content format.

FIG. 14 is an example of a typical module and the technical specifics for a PDA page

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a system and method for the delivery of education solutions via handheld devices with minimal cost, training or infrastructure requirements.

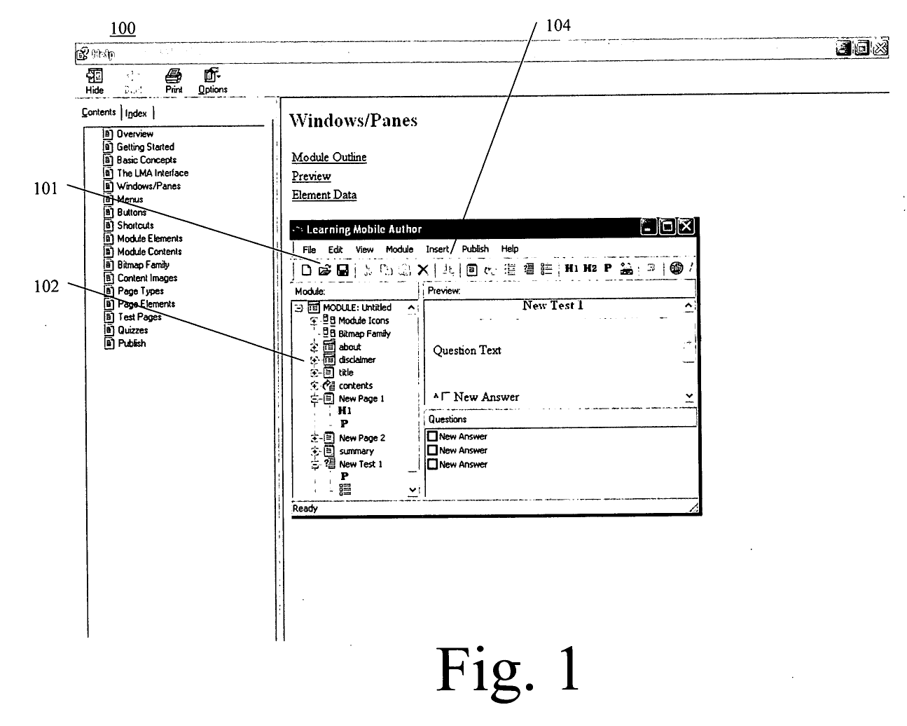

Now referring to FIG. 1 the graphical user interface 100 of the present invention is shown. The present invention has a windows friendly development environment. Users are able to use buttons 101, menus 102 or shortcut keystrokes 103 to edit their content. Thus, the tools are very flexible for those who are comfortable with windows based applications. The interface 100 of the present invention allows users to add, modify and arrange their learning content with quick one click button functionality. A menu bar 104 gives users full control of their content editing environment. Users can accomplish a number of tasks such as adding new elements to their module, compiling their modules for deployment, or even editing the layout of the interface tool.

Shortcut keystrokes are available to add flexibility into the LMA tool for users who like to use shortcuts. These keys allow users to file, edit, add and insert content into their mobile learning activity.

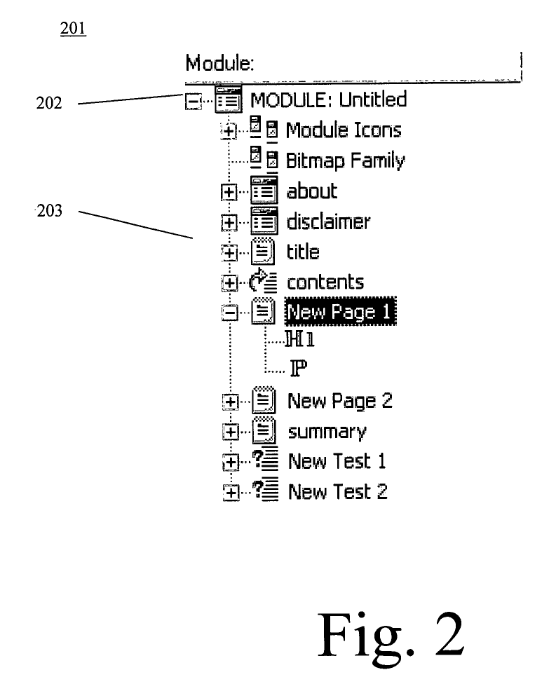

Now referring to FIG. 2, the Module Outline Pane 201 is home to the structure of a module. It is similar to a table of contents in a book. Each element 202 of a module 203 is arranged in a linear format so that as a user moves down the outline in this pane 201 they see the pages of their module as they would appear to a student user in a linear sequence.

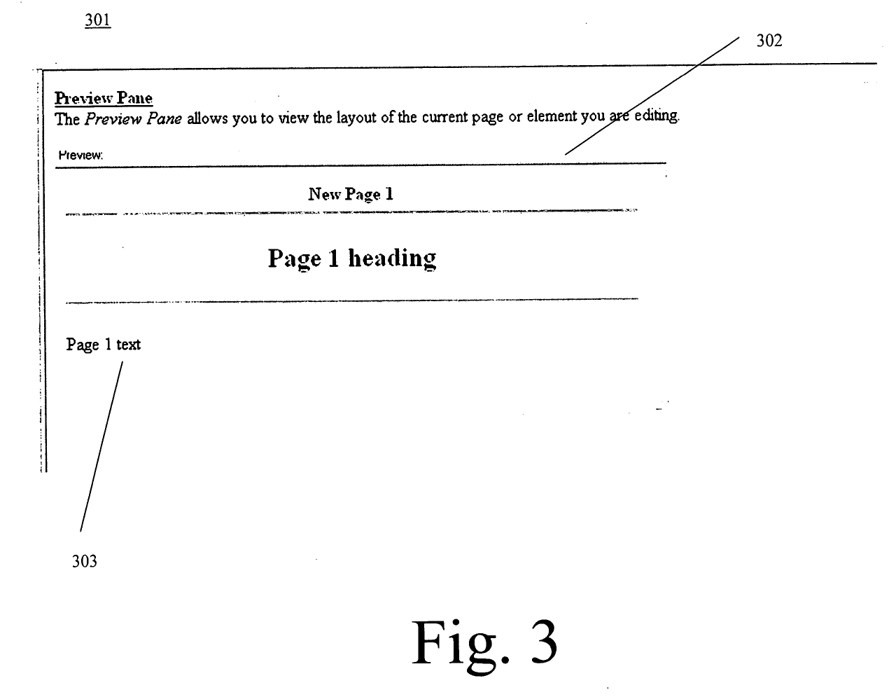

Now referring to FIG. 3, the Preview Pane 301 allows a user to view the layout of the current page 302 or element 303 they are editing.

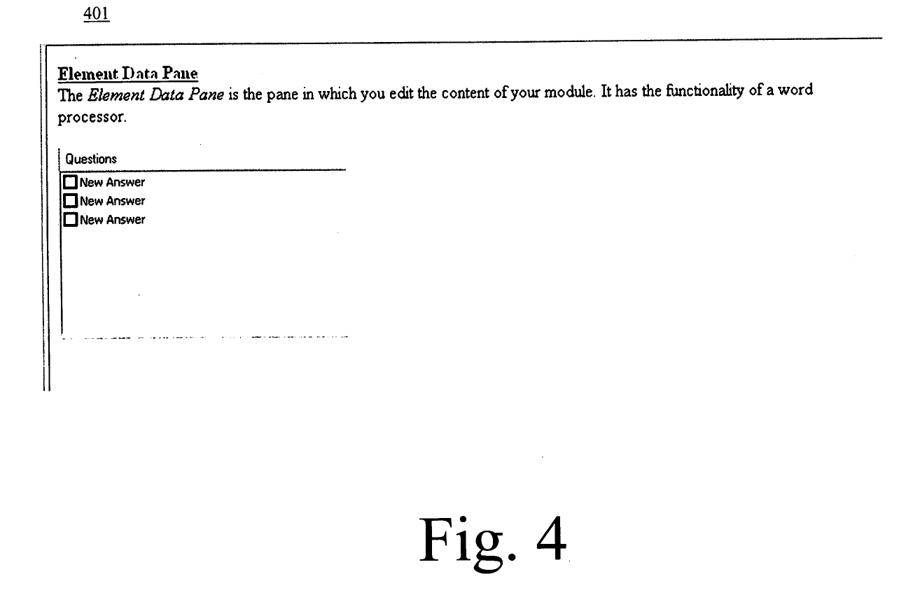

Now referring to FIG. 4, the Element Data Pane 401 is the pane in which a user edits the content of their module. the Element Data Pane 401 has the functionality of a standard electronic word processor.

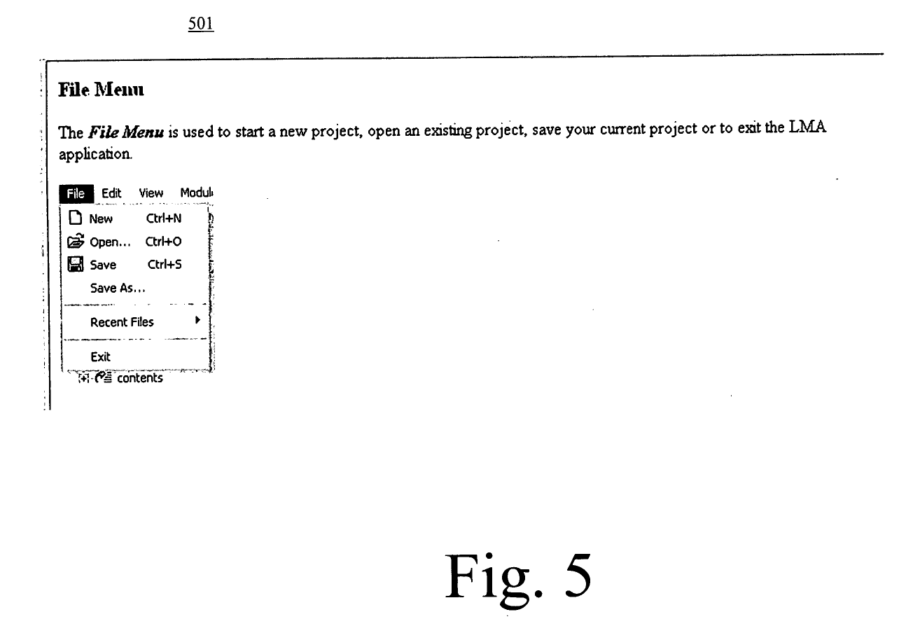

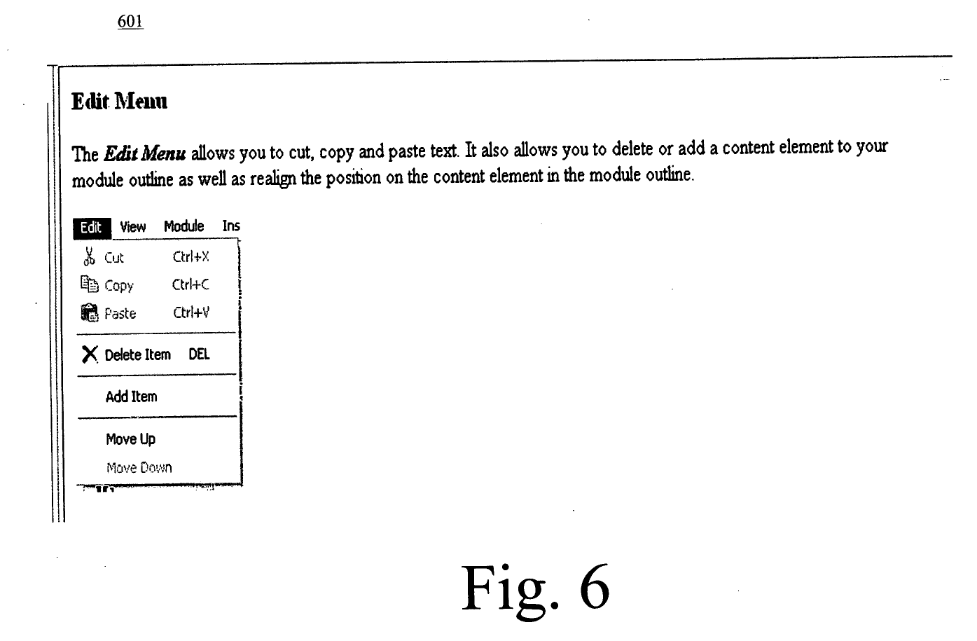

In the present invention, a menu bar gives the user full control of their content editing environment. A user can accomplish a number of tasks such as adding new elements to their module, compiling their modules for deployment, or even editing the layout of their interface tool. Referring to FIG. 5, a File Menu 501 is used to start a new project, open an existing project, save a current project or to exit the interface. The Edit Menu 601 of FIG. 6 allows a user to cut, copy and paste text. The Edit Menu 601 also allows users to delete or add a content element to their module outline as well as realign the position on the content element in the module outline.

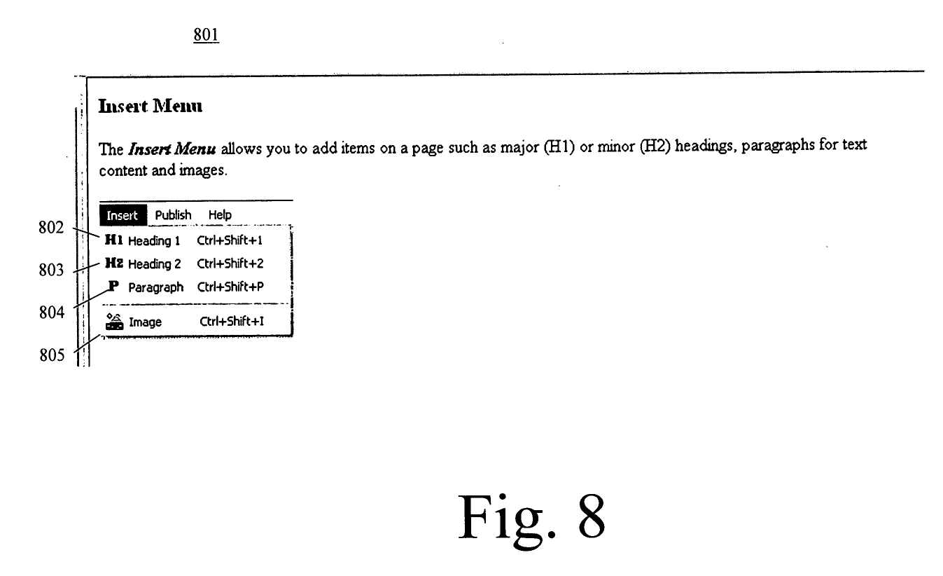

the Insert Menu 801 shown in FIG. 8 allows users to add items on a page such as major (H1) 802 or minor (H2) 803 headings, paragraphs for text content 804, and images 805.

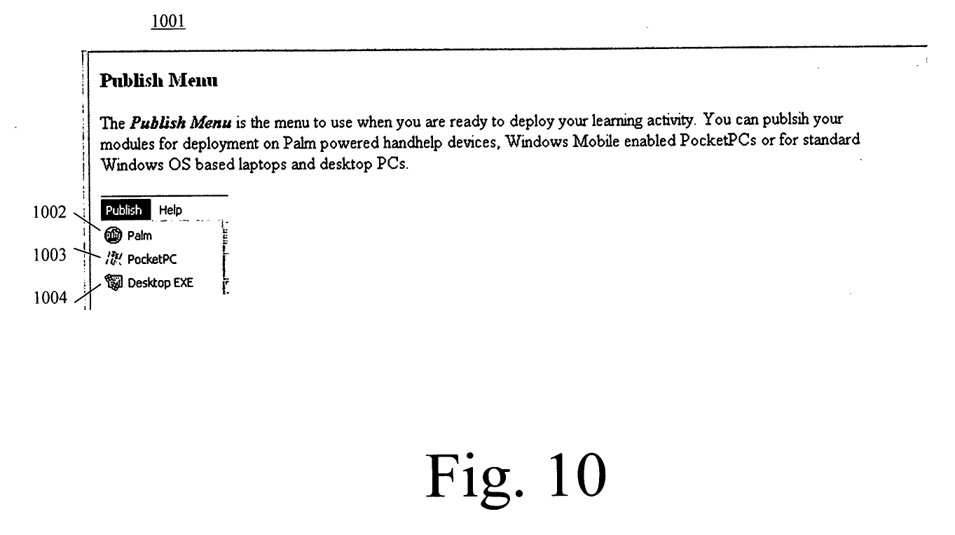

The Publish Menu 1001 illustrated in FIG. 10 is used when a user is ready to deploy their learning activity. The user can publish their modules for deployment on Palm powered handheld devices, Windows Mobile enabled PocketPCs 1002 or for standard Windows OS based laptops 1003 and desktop PCs 1004.

Shortcut keystrokes are available to add flexibility into the interface tool for those who like to use shortcuts. These keys allow a user to file, edit, add and insert content into their mobile learning activity.

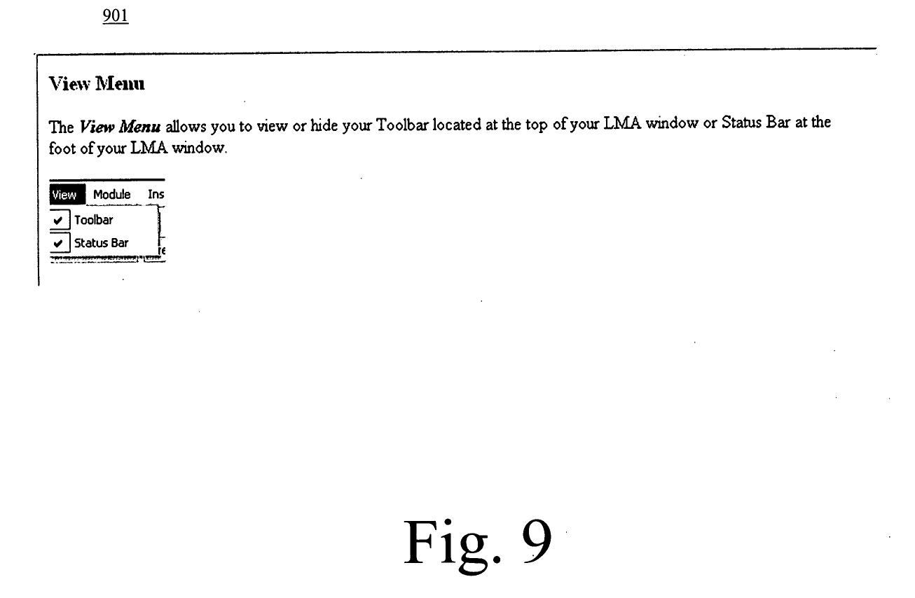

A File Menu is used to start a new project, open an existing project, save a current project or to exit the LMA application. An Edit Menu allows a user to cut, copy and paste text. The edit menu also allows a user to delete or add a content element to their module outline as well as realign the position on the content element in the module outline. A Module Menu allows a user to add pages, quizzes and tests to their module. The Module Menu also allows a user to add list item elements to a page or to add new image families or images to an image family. An Insert Menu allows a user to add items on a page such as major (H1) or minor (H2) headings, paragraphs for text content and images. A View Menu 901 as illustrated in FIG. 9 allows a user to view or hide their toolbar located at the top of the window or the status bar located at the bottom of the window.

A mobile learning activity consists of a number of different elements that form the basis of a module. It is good design practice for a user to think about the layout of a module before hand. Once a plan is in place, the user can begin to develop a template for their learning activity by placing key elements into their module outline located in the module pane of the user interface. A user will need to become familiar with the different modules elements listed below.

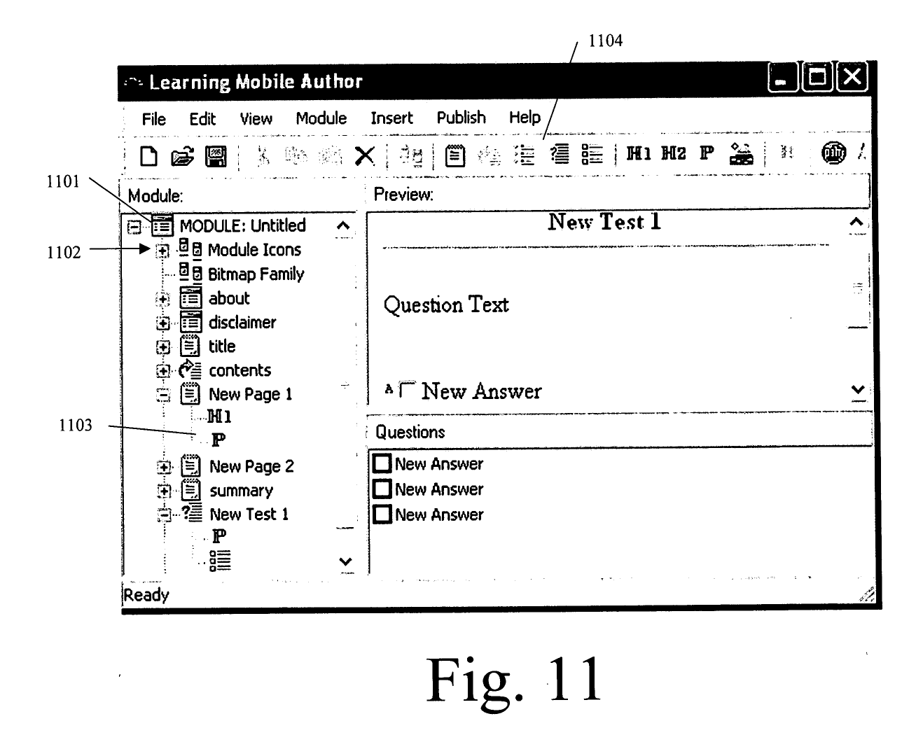

Now referring to FIG. 11, the Module 1101 represents a user's current project. Below the module element are all of the content elements 1102 and sub elements 1103 that make up a learning activity. The module elements are the first elements that a user will edit in order to name their project and include other important creation information such as the developer of the learning activity.

Module Icons 1104 are the shortcut images that a student user will see on their device's desktop that launches the learning activity. The present invention has two standard icon types to accommodate the different handheld devices currently known in the prior art and their operating systems. They are large icons and small icons.

Bitmap Families are image folders where user will place one image. The images of the bitmap family make up all of the content images of a module. The images from these will be added to a page by using the Add Image button or shortcut from the Insert Menu. Currently, users must pay close attention to the images placed in the bitmap family. Images may be any size but a user must ensure that the size is appropriate for the device as there is no auto size correction feature at this time. For example, if a user has a Pocket PC with a viewing screen size of 250 pixels by 250 pixels, then it is best that there not be a bitmap in a bitmap family that is 320 pixels by 320 pixels. Once images have been added to a bitmap family, the image can be place on a page element by clicking the Image Button or using the shortcut keystroke for inserting an image.

The user interface allows a user to add information about their module. To add an About data, a user must highlight the paragraph element under the About element and begin typing their text in the paragraph pane on the bottom right of the interface window.

The interface also allows a user to add disclaimer information regarding their module. To add a disclaimer, a user must highlight the paragraph element under the disclaimer element and begin typing their text in the paragraph pane on the bottom right of the interface window.

A table of contents serves two purposes in a mobile learning module. First, the table of contents references the content within a module and second, it allows navigation to key content without having to page through the entire module. A table of contents may be added to any module by clicking the table of contents button on the button bar or by selecting it from the module menu. A table of contents is populated by adding major (H1) and/or minor (H2) headings to a page element.

The majority of content in a user's module will be housed on a Page Element with the exception of Tests and Table of Contents. Based on the content that is place on a page, this will designate the type of page a user has created.

For example: a text page has one or two paragraphs and or headings, an image page contains images, a list page contains list items, a quiz page contains quiz elements, and a hybrid page may contain any combination of the previously mentioned elements.

A Test Page is automatically populated with a Paragraph element and a Quiz element to allow a user to type the question in the paragraph element and to provide the multiple choice responses in the quiz element. It is important to note that both elements reside on the same page.

A special point of information here is to understand that True and False question are also considered multiple-choice questions. However, a user will need to delete the last quiz response item since the quiz element defaults to three response items. Conversely, a user may add more response items by right clicking on the response items and select add new item.

To designate a question as a single response question, a user must place a check in the box to the left of the correct response. Then the interface will automatically understand that this is the correct response and provide feedback based on that response. Student users will not see this on their screen unless they answer the question incorrectly three times.

To designate a question as a multiple response question, a user must place a check in the boxes to the left of the correct responses. Then the interface will automatically understand that theses are the correct responses and provide feedback based on those responses. Student users will not see this on their screen unless they answer the question incorrectly three times.

A Quiz Page must be created by adding a Paragraph element and a Quiz element to a Page element. A user must then type the question in the Paragraph element and provide the multiple-choice responses in the Quiz element. It is also important to note that both elements should reside on the same page.

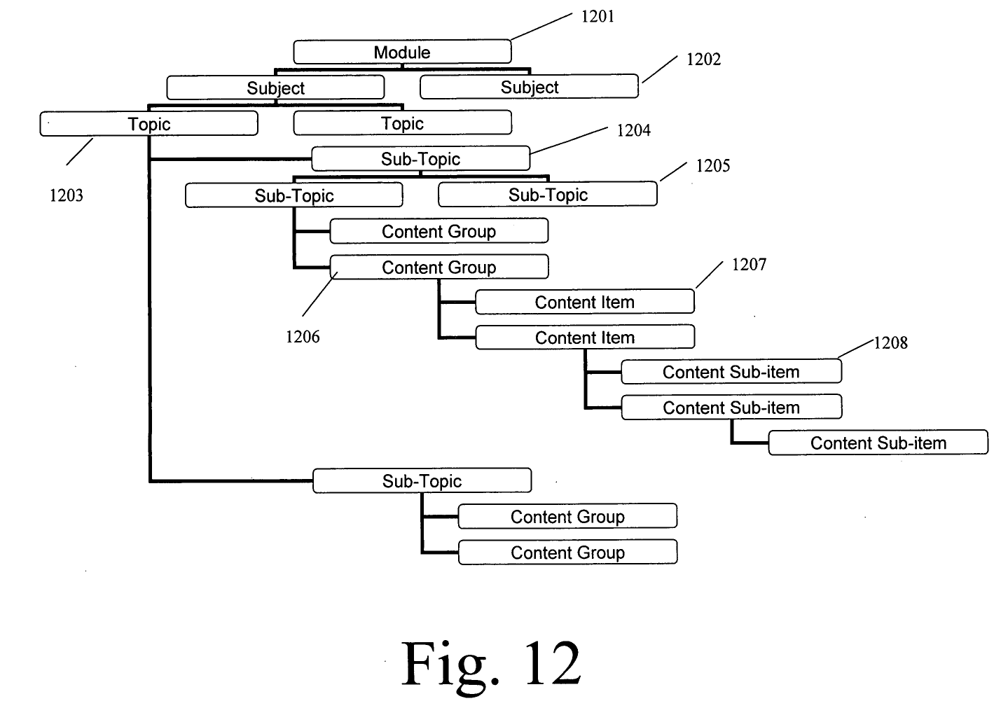

Now referring to FIG. 12, a flow chart of the Module Content Data Model is illustrated. A module 1201 is comprised of one or more subjects 1202. Subjects 1202 can be segregated into topics 1203 and subtopics 1204. A subtopic 1204 or a second subtopic 1205 of a first subtopic is further defined by content groups 1206, content items 1207, and content sub-items 1208.

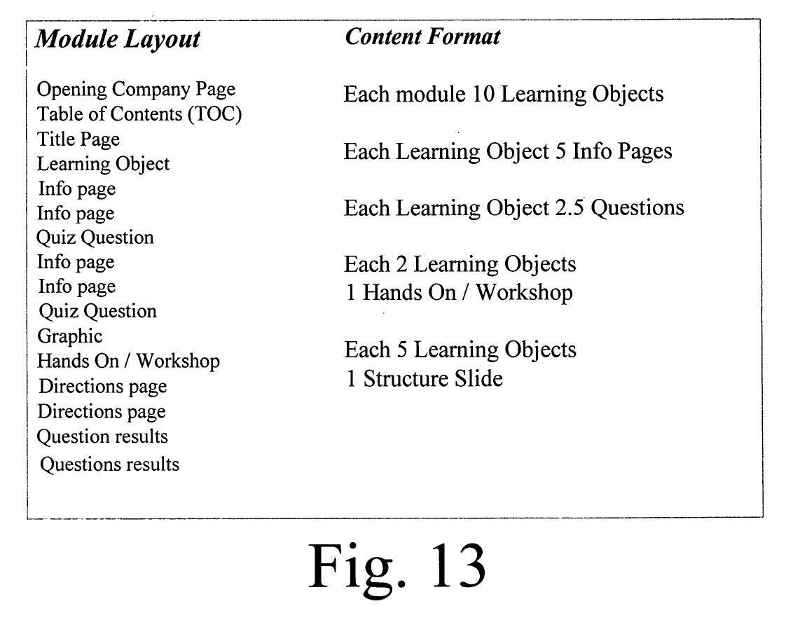

FIG. 13 is an example of a typical module layout and content format illustrating. The common contents of typical module layout as well as the content format include but are not limited to an opening page, table of contents, information pages, quiz pages, and direction pages. Each module can contain multiple learning objects, information pages, quizzes, and learning objects.

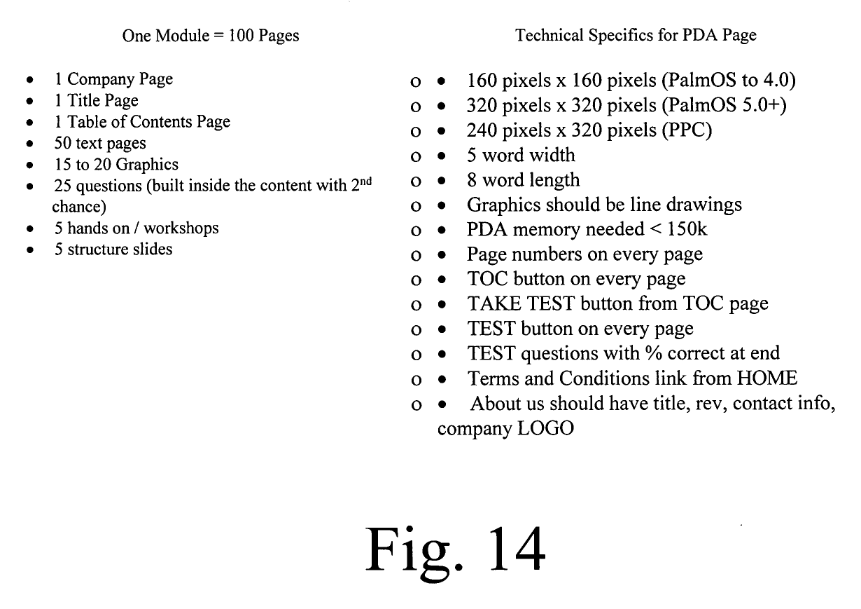

FIG. 14 is an example of a typical module and the technical specifics for a PDA page. The example module contains 100 pages of material as illustrated. The technical specifications provided are only to illustrate the current best mode of the present invention as applied to mobile learning content for generating a PDA page.

Module content flow start with obtaining the target device settings, calculate course mapping, transferring the course content data to device page, determine resource mapping, and resource format and detail to device capabilities for each resource type.

In an alternative embodiment, the present invention could be used to create a content for use on mobile devices in the pharmaceutical industry. For example, a company could use the present invention to create and distribute to its sales force new or evolving product information. In this manner, the sales force would have at their disposal company and product information such as sales strategy, medical definitions and diagnoses, and treatment options to for them to refer to during a sales meeting. Additionally, the content could further contain information on a drug or treatment system such as its chemical formula, warnings, conflicts with other drugs, and ordering information.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for creating mobile content comprising:
a graphical user interface;
a windows development environment;
buttons, menus, and shortcut keystrokes for editing their content;
said shortcut keystrokes enable filing, editing, adding and inserting content into a mobile learning content;
said interface enables the addition, modification and arrange of learning content utilizing one click button functionality;
a file menu for starting a new project, opening an existing project, saving a current project, or to exiting the interface; and
a menu bar for: content editing, adding new elements, compiling modules for deployment, or editing the layout of the interface tool.

2. The method for creating mobile content of claim 1 wherein said interface is further comprised of:
a module outline pane providing the structure of a module;
said module outline pane displaying each module element arranged in a linear format at they would appear to a student user in a linear sequence;
a preview pane for viewing the layout of a current page or element being editing; and
an element data pane providing editing of the content of a module.

3. The method for creating mobile content of claim 2 wherein said menu bar provides control of the content editing environment enabling the adding of new elements to a module, compiling modules for deployment, or editing the layout of the interface tool.

4. The method for creating mobile content of claim 2 further comprising:
an edit menu for enabling the cutting, coping and pasting of text and the deletion or addition to the content element of a module outline as well as realign the position on the content element in the module outline;
a module menu enabling the addition of pages, lists, quizzes, and tests to a module;
an insert menu that enables the addition of items on a page;
a view menu enabling the viewing or hiding of the toolbar located at the top of the window or the status bar located at the bottom of the window; and
a publish menu enabling the publication of modules for deployment on mobile electronic devices.

5. The method for creating mobile content of claim 4 wherein the module menu further enables the addition of list item elements to a page or to add new image families or images to an image family.

6. The method for creating mobile content of claim 4 wherein said mobile electronic devices include handheld devices, Windows Mobile enabled PocketPCs or Windows OS based laptops and desktop personal computers.

7. The method for creating mobile content of claim 2 further comprising an edit menu enabling:
the cutting, copying, and pasting of text; and
deletion or addition of content elements to a module outline as well as realign the position on the content element in the module outline.

8. The method for creating mobile content of claim 2 further comprising a module menu enabling:
the addition of pages, quizzes and tests to a module; and
the addition of list item elements to a page or to add new image families or images to an image family.

9. The method for creating mobile content of claim 2 further comprising two standard module icon types, large and small, to accommodate the different handheld devices and their operating systems

10. The method for creating mobile content of claim 2 further comprising bitmap families wherein:
the images of the bitmap family make up all of the content images of a module;
said images are added to a page using an add image button or shortcut from an insert menu; and
once said images are added to a bitmap family, said images can be place on a page element by clicking the image button or using the shortcut keystroke for inserting an image.

11. The method for creating mobile content of claim 2 wherein said interface enables the addition of informational data element and a disclaimer element by highlighting the paragraph element under the desired element and entering text in the paragraph pane on the bottom right of the interface window.

12. The method for creating mobile content of claim 2 further comprising a table of contents that references the content within a module and allows navigation directly to key content.

13. The method for creating mobile content of claim 2 wherein the majority of content in a module will be housed on a page element with the exception of Tests and Table of Contents.

14. The method for creating mobile content of claim 13 wherein a test page is automatically populated with a paragraph element and a quiz element to enable entry of a question in the paragraph element and to provide the multiple choice responses in the quiz element

15. The method for creating mobile content of claim 14 wherein to designate a question as a single response question, a check must be placed in a box to the left of the correct response and said interface will automatically understand that this is the correct response and provide feedback based on that response.

16. The method for creating mobile content of claim 14 wherein to designate a question as a multiple response question, a check must be place in the boxes to the left of the correct responses, said interface will automatically understand that theses are the correct responses and provide feedback based on those responses.

17. The method for creating mobile content of claim 14 wherein a quiz page is created by adding a paragraph element and a quiz element to a page element requiring entry of the question in the paragraph element and requiring the multiple-choice responses in the quiz element.

18. A mobile content development system available that allows users to author content using a simple to use authoring environment and then, with a simple click of a button, publish to any mobile device such as a Palm OS, Pocket PC and similar mobile desktop environments by create five different types of content: checklists, job aides, quizzes, tests, and mobile learning.
